(19) United States
(12) Patent Application Publication
(10) Pub. No.: US 2007/0136502 A1
(43) Pub. Date: Jun. 14, 2007

(54) SPI device

(75) Inventors: Chih-Chiang Wen, Hsinchu Hsien (TW); Pao-Ching Tseng, Chubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/300,224

(22) Filed: Dec. 14, 2005

(51) Int. Cl. G06F 13/00

(52) U.S. Cl. 710/110

(57) ABSTRACT

A SPI device. The SPI device comprises a serial clock pin, a chip select pin, a data input pin, and a data output pin. The serial clock pin transmits a serial clock from a master device to a slave device. The chip select pin determines whether the slave device is selected by the master device. The data input pin transfers instructions, addresses, data to be programmed, dummy input or a combination thereof from the master device to the slave device. The data output pin transfers data from the slave device to the master device. The SPI device acts as the master device or the slave device. One pin other than the data output, serial clock and chip select pins acts as an additional data output pin when the data output pin transfers data from the slave device to the master device.

### BACKGROUND

The invention relates to a serial peripheral interface (SPI) device and, in particular, to a SPI device with higher access bandwidth.

Many current digital systems utilize peripherals that have no major speed requirement. A serial bus minimizes the number of pins, and the size of the package of integrated circuits at reduced costs. Accordingly, SPI (serial peripheral interface) devices have been increasingly used in different digital systems due to lower layout complexity in printed circuit boards (PCBs) and pad-limited chips. Data bus width in SPI devices, however, is only 1-bit limiting access bandwidth of the digital system.

FIG. 1 is a schematic diagram of a conventional SPI system comprising a master device 101 and a slave device 101′, each comprising a serial clock pin 103/103′, a chip select pin 105/105′, a data input pin 107/107′, a data output pin 109/109′, a hold pin 111/111′, and a write protect pin 113/113′. Signals between the master device and the slave device are unidirectional. FIG. 2 shows waveforms of signals in the conventional SPI system in FIG. 1. A chip select signal CS_ on the chip select pin 105/105′ is asserted low when the master device accesses data from the slave device. A serial instruction (8 bits), an address (24 bits) and a dummy byte (8 bits) for a fast read instruction are serially transmitted to the slave device via a data input pin 107/107′. After the slave device receives the serial instruction, the address and the dummy byte from the master device, a corresponding response to the serial instruction is serially fed back to the master device via the data output pin 109/109′. The data input pin 107/107′ does not transmit any meaningful data when the data output pin 109/109′ transfers data from the slave device to the master device. All signals in the conventional SPI system are unidirectionally transmitted and received. In FIG. 2, the first byte is completely fed back at the 47th cycle and 8 clock cycles are required to retrieve one-byte data. Performance of the conventional SPI system is thus affected.

### SUMMARY

An embodiment of a SPI device comprises a serial clock pin, a chip select pin, a data input pin, and a data output pin. The serial clock pin transmits a serial clock from a master device to a slave device. The chip select pin determines whether the slave device is selected by the master device. The data input pin transfers instructions, addresses, data to be programmed, dummy input or a combination thereof from the master device to the slave device. The data output pin transfers data from the slave device to the master device. The SPI device acts as the master device or the slave device. A pin other than the data output, serial clock, and chip select pins serves as an additional data output pin when the data output pin transfers data from the slave device to the master device.

Another embodiment of a SPI device comprises a serial clock pin, a chip select pin, a data input pin, and a data output pin. The serial clock pin transmits a serial clock from a master device to a slave device. The chip select pin determines whether the slave device is selected by the master device. The data input pin transfers instructions, addresses, data to be programmed, dummy input or a combination thereof from the master device to the slave device. The data output pin transfers data from the slave device to the master device. The SPI device acts as the master device or the slave device. A pin other than the data input, serial clock, and chip select pins serves as an additional data input pin for address input, data input, dummy input or a combination thereof.

Another embodiment of a SPI device comprises a serial clock pin, a chip select pin, and a data input/output pin. The serial clock pin transmits a serial clock from a master device to a slave device. The chip select pin determines whether the slave device is selected by the master device. The data input/output (DIO) pin transfers instructions, addresses, data to be programmed, dummy input or a combination thereof from the master device to the slave device and transfers data from the slave device to the master device. The SPI device acts as the master device or the slave device.

The invention converts one unidirectional pin in a conventional SPI system to a bidirectional pin such that access bandwidth of the SPI system is increased.

### BRIEF DESCRIPTION OF THE DRAWINGS

FIG. 1 is a schematic diagram of a conventional SPI system comprising a master device and a slave device.

FIG. 2 shows waveforms of signals in the conventional SPI system in FIG. 1.

FIG. 3 is a schematic diagram of a SPI system comprising a master device and a slave device according to an embodiment of the invention.

FIG. 4 shows waveforms of signals in the SPI system in FIG. 3.

FIG. 5 is a schematic diagram of a SPI system comprising a master device and a slave device according to another embodiment of the invention.

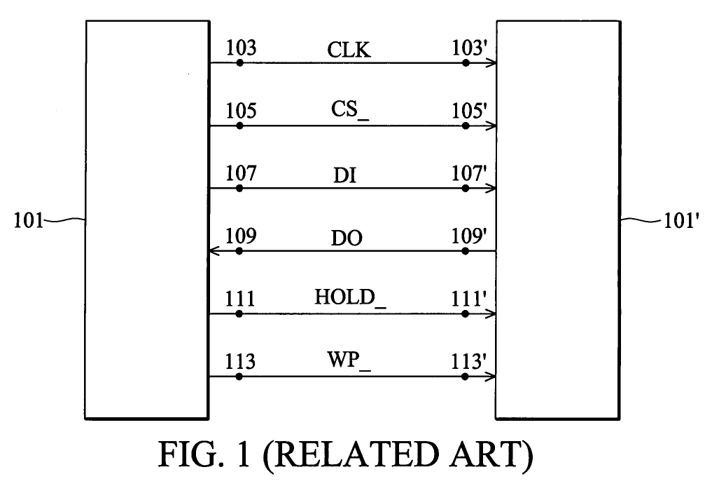

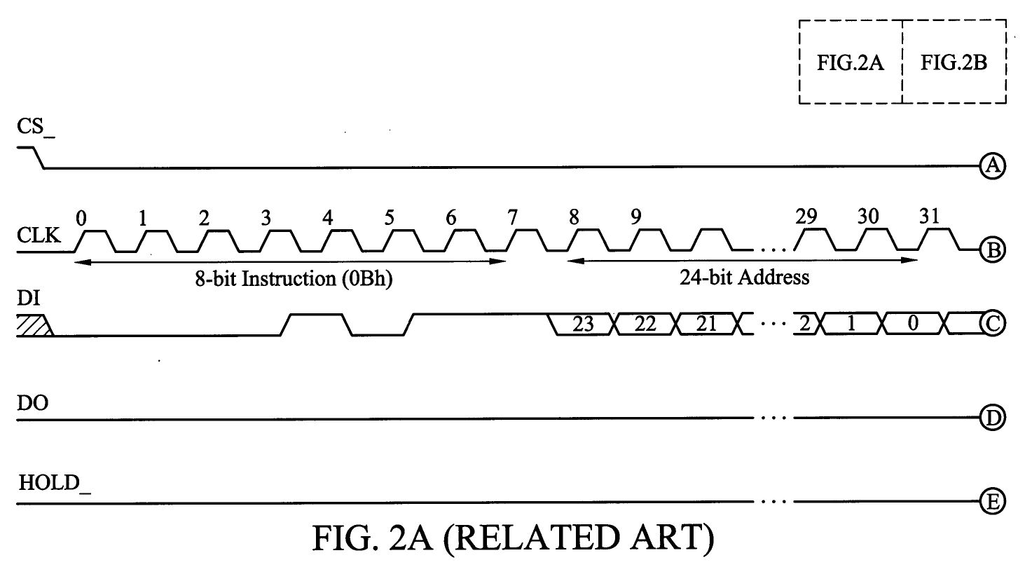

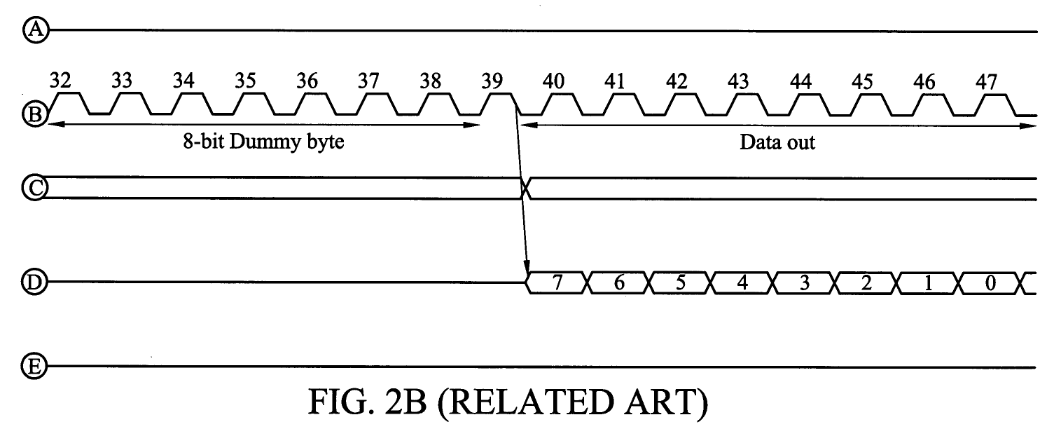

### DETAILED DESCRIPTION

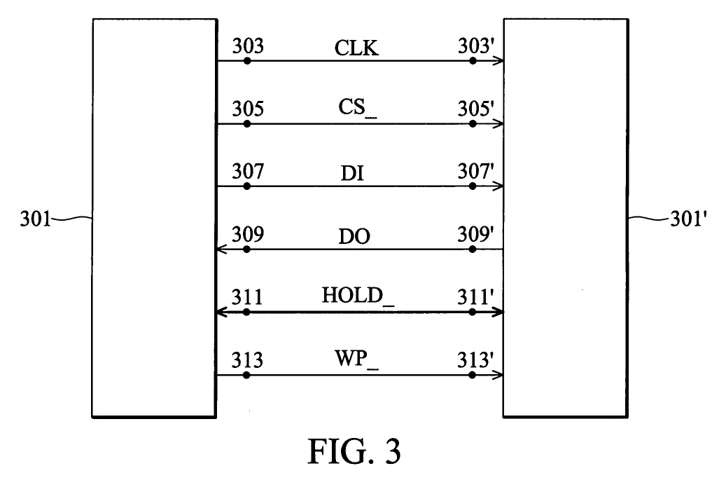

FIG. 3 is a schematic diagram of a SPI system comprising a master device 301 and a slave device 301′ according to an embodiment of the invention. The master device 301 sends instructions to the slave device 301′. Each of the master device 301 and the slave device 301′ in the SPI system has a serial clock pin 303/303′, a chip select pin 305/305′, a data input pin 307/307′, a data output pin 309/309′, a hold pin 311/311′, and a write protect pin 313/313′. All signals, except a signal on the hold pin 311/311′, between the master device 301 and the slave device 301′ are unidirectional. The serial clock pin transmits a serial clock from the master device 301 to the slave device 301′. The chip select pin 305/305′ transmits a chip select signal CS_ to determine whether the slave device 301′ is selected by the master device 301. The data input pin transfers input information from the master device 301 to the slave device 301′. The input information comprises instructions, addresses, data to be programmed, dummy input or a combination thereof. The data output pin 309/309′ transfers output information from the slave device 301 to the master device 301′. The hold pin 311/311′ pauses any serial communications with the slave device 301′ without deselecting the slave device 301′. The write protect pin 313/313′ protects the slave device 301′ from being programmed or erased. The “pin” referred in the disclosure can be a terminal for data transmission, but not necessarily a physical pin.

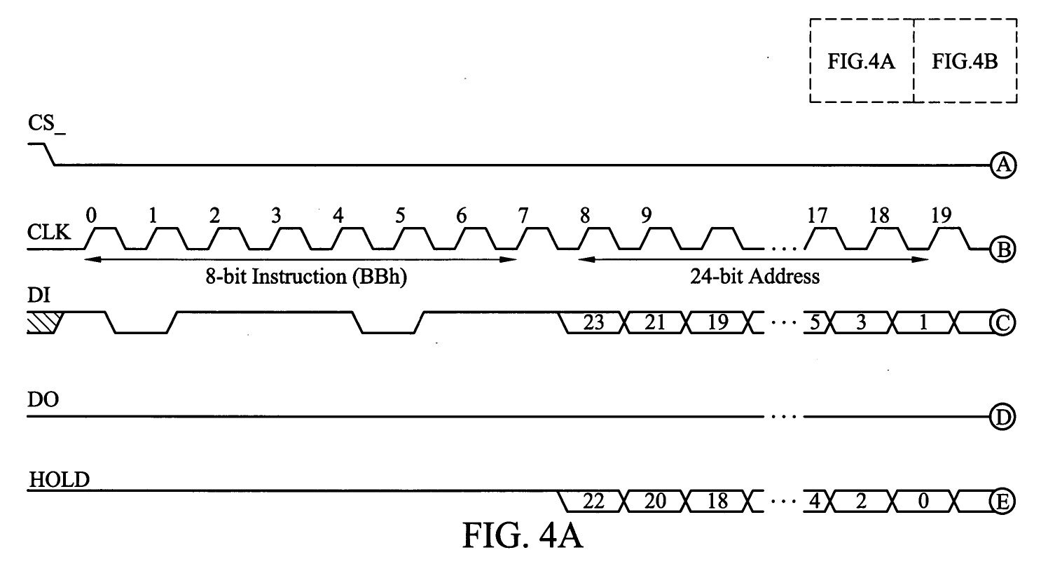

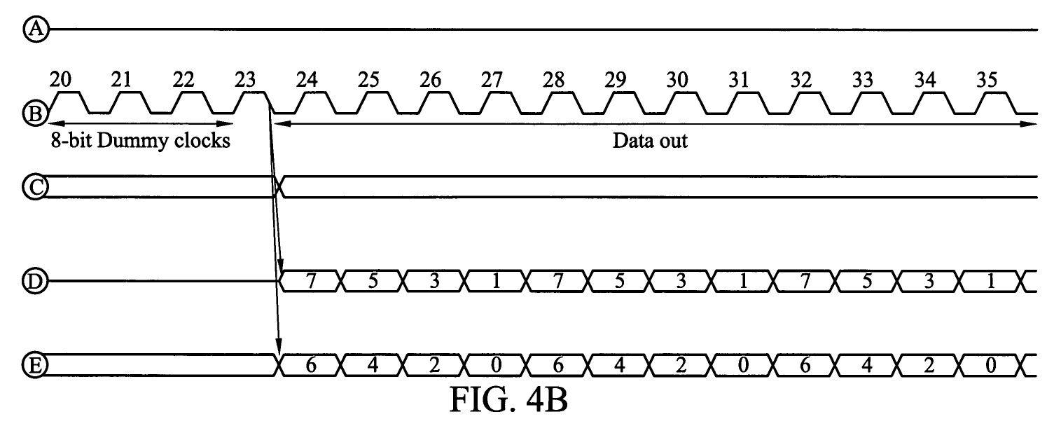

FIG. 4 shows waveforms of signals in the SPI system in FIG. 3. A chip select signal CS_ is asserted low when the master device 301 accesses data from the slave device 301′. A serial instruction (8 bits) is transmitted to the slave device 301 via a data input pin 307/307′. The hold pin 311/311′ serves as another data input pin for address input and dummy input after the slave device 301 receives a special instruction, such as fast read dual input-output (BBh) shown in FIG. 4, from the master device 301. The instruction fast read dual input-output (BBh) enables the hold pin HOLD_ to transfer output information from the slave device to the master device. The address (24 bits) is simultaneously transmitted to the slave device 301′ via the data input pin 307/307′ and the hold pin 311/311′. Following address transmission, the dummy byte (8 bits) is also simultaneously transmitted to the slave device 301′ via the data input pin 307/307′ and the hold pin 311/311′. As a result, only 16 clock cycles are required for address and dummy byte transmission. The SPI system according to an embodiment of the invention also differs from the conventional SPI system in that the hold pin HOLD_ serves as another data output pin after the dummy byte is transmitted to the slave device 301′. The slave device 301′ simultaneously drives data output via the data output pin 309/309′ and the hold pin 311/311′. As a result, throughput of data transmission is doubled. The master device 301 receives a first complete data byte at the 27th cycle and only 4 clock cycles are required to retrieve one-byte data such that performance of the SPI system is improved without the requirement for additional pins.

In the disclosure, the hold pin 311/311′ is rarely used and serves as an additional channel for both address and data transmission, although the invention is not limited thereto. In a SPI system according to the invention, one pin other than the data output, serial clock and chip select pins can also transfer output information from the slave device to the master device. In addition, one pin other than the data input, serial clock and chip select pins can also transfer input information from the master device to the slave device.

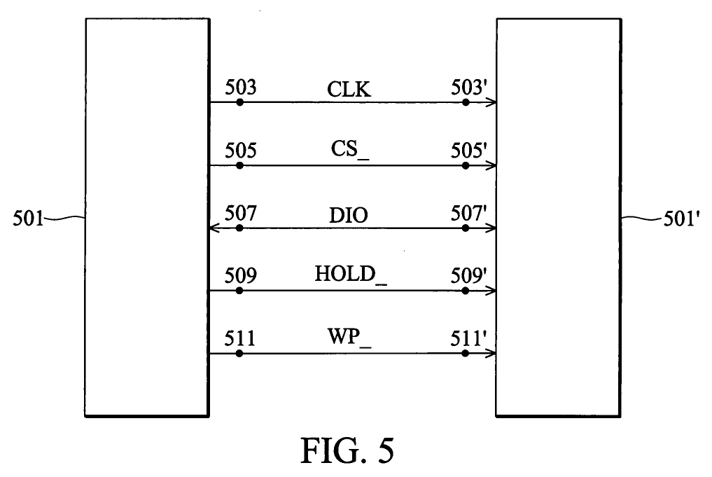

FIG. 5 is a schematic diagram of a SPI system comprising a master device 501 and a slave device 501′ according to another embodiment of the invention. Each of the master device 501 and the slave device 501′ in the SPI system has a serial clock pin 503/503′, a chip select pin 505/505′, a data input/output pin 507/507′, a hold pin 509/509′, and a write protect pin 511/511′. All signals, except a signal on the data input/output pin 507/507′, between the master device 501 and the slave device 501′ are unidirectional. The serial clock and chip select pins have the same function as in the previous embodiment. The data input/output pin 507/507′ transfers input information from the master device 501 to the slave device 501′ when the slave device 501′ is selected via the chip select pin 505/505′. In addition, the data input/output pin 507/507′ transfers output information from the slave device 501′ to the master device 501 after the slave device 501′ receives an instruction and returns corresponding data.

While the invention has been described by way of example and in terms of preferred embodiment, it is to be understood that the invention is not limited thereto. To the contrary, it is intended to cover various modifications and would be apparent to those skilled in the art. Therefore, the scope of the appended claims should be accorded the broadest interpretation so as to encompass all such modifications.

What is claimed is:

1. A serial peripheral interface (SPI) device, comprising:
a serial clock pin, via which a serial clock is transmitted from a master device to a slave device;
a chip select pin, carrying a chip select signal according to which whether the slave device is selected by the master device is determined;
a data input pin, via which input information is transferred from the master device to the slave device; and
a data output pin, via which output information is transferred from the slave device to the master device;
wherein the SPI device acts as the master device or the slave device and one pin other than the data output, serial clock and chip select pins acts as an additional data output pin when the data output pin transfers data from the slave device to the master device.

2. The SPI device of claim 1, wherein the data input pin acts dynamically as the additional data output pin.

3. The SPI device of claim 1, further comprising a hold pin, pausing serial communication with the slave device without deselecting the slave device, and a write protect pin, protecting the slave device from being programmed or erased.

4. The SPI device of claim 3, wherein the hold pin dynamically serves as the additional data output pin.

5. The SPI device of claim 3, wherein the write protect pin dynamically serves as the additional data output pin.

6. A serial peripheral interface (SPI) device, comprising:
a serial clock pin, via which a serial clock is transmitted from a master device to a slave device;
a chip select pin, carrying a chip select signal according to which whether the slave device is selected by the master device is determined;
a data input pin, via which input information is transferred from the master device to the slave device; and
a data output pin, via which output information is transferred from the slave device to the master device;
wherein the SPI device acts as the master device or the slave device and one pin other than the data input, serial clock and chip select pins acts as an additional data input pin for address input, data input, dummy input or a combination thereof.

7. The SPI device of claim 6, wherein the data output pin acts dynamically as the additional data input pin.

8. The SPI device of claim 6, further comprising a hold pin, pausing serial communication between the master and slave devices without deselecting the slave device, and a write protect pin, protecting the slave device from being programmed or erased.

9. The SPI device of claim 8, wherein the hold pin acts dynamically as the additional data input pin.

10. The SPI device of claim 8, wherein the write protect pin acts dynamically as the additional data input pin.

11. A serial peripheral interface (SPI) device, comprising:
a serial clock pin, transmitting a serial clock from a master device to a slave device;
a chip select pin, determining whether the slave device is selected by the master device;
a data input/output (DIO) pin, via which input and output information is between the master device to the slave device; and
wherein the SPI device acts as the master device or the slave device.

12. The SPI device of claim 11, further comprising a hold pin, pausing serial communication between the master and slave devices without deselecting the slave device, and a write protect pin, protecting the slave device from being programmed or erased.
